(19) United States
(12) Patent Application Publication
(10) Pub. No.: US 2024/0404538 A1
(43) Pub. Date: Dec. 5, 2024

(54) SOUND ENCODING METHOD AND SOUND DECODING METHOD, RELATED APPARATUS, AND SYSTEM

(71) Applicant: Honor Device Co., Ltd., Shenzhen (CN)

(72) Inventor: Jianfeng Xu, Shenzhen (CN)

(21) Appl. No.: 18/694,276

(22) PCT Filed: May 6, 2023
(86) PCT No.: PCT/CN2023/092547

§ 371 Date: Mar. 21, 2024

(30) Foreign Application Priority Data
Jul. 29, 2022 (CN) 202210908196.9

(51) Int. Cl. G10L 19/038; G10L 19/00

(52) U.S. Cl. CPC G10L 19/038; G10L 2019/0002

(57) ABSTRACT

Embodiments of this application provide a sound encoding method and a sound decoding method, a related apparatus, and a system. First, a linear estimated value of an algebraic codebook gain in a linear domain may be obtained through table lookup according to an index CT_{index} of a classification parameter CT of a current frame. Then, the linear estimated value of the algebraic codebook gain in the linear domain is divided by energy (which is represented as \sqrt{E_{c}}) of an algebraic codebook vector from an algebraic codebook in the linear domain, to obtain an estimated gain g_{c0}^{[0]} of the algebraic codebook in the first subframe.

### CROSS-REFERENCE TO RELATED APPLICATIONS

This application is a national stage of International Application No. PCT/CN2023/092547, filed on May 6, 2023, which claims priority to Chinese Patent Application No. 202210908196.9, filed on Jul. 29, 2022. The disclosures of both of the aforementioned applications are hereby incorporated by reference in their entireties.

### TECHNICAL FIELD

This application relates to the field of audio encoding and decoding, and in particular, to audio encoding and decoding technologies based on code-excited linear prediction (code-excited linear prediction, CELP).

### BACKGROUND

A code-excited linear prediction (CELP) technology can implement compromise between good quality and a good bit rate, which is first proposed by Manfred R. Schroeder and Bishnu S. Atal in 1985. In a CELP encoder, input voice or an audio signal (a sound signal) is processed by using a frame as a unit. The frame is further divided into a smaller block, and the smaller block is referred to as a subframe. In a codec, an excitation signal is determined in each subframe and includes two components: One is from past excitation (which is also referred to as an adaptive codebook), and the other is from an algebraic codebook (which is also referred to as a fixed codebook or a creative codebook). An encoding side transmits encoding parameters such as an algebraic codebook gain and an adaptive codebook gain instead of original sound to a decoding side, and the encoding parameters are calculated when an error between a reconstructed voice signal sound and an original voice signal is a minimum value. How to reduce calculation complexity is a hotspot of research in the field.

### SUMMARY

Embodiments of this application provide a sound encoding method and a sound decoding method, which can reduce complexity of calculating a codebook gain.

According to a first aspect, a method for encoding a sound signal is provided, applied to a first subframe in a current frame. The method may include: receiving a frame classification parameter index of the current frame, searching a first mapping table for a linear estimated value of an algebraic codebook gain in a linear domain according to the frame classification parameter index of the current frame, where each entry in the first mapping table includes two values: a frame classification parameter index and a linear estimated value of an algebraic codebook gain in the linear domain, calculating energy of an algebraic codebook vector from an algebraic codebook, dividing the linear estimated value of the algebraic codebook gain in the linear domain by a square root of the energy of the algebraic codebook vector, to obtain an estimated gain of the algebraic codebook, and then multiplying the estimated gain of the algebraic codebook by a correction factor, to obtain a quantized gain of the algebraic codebook. The correction factor is from a winning codebook vector, and the winning codebook vector is selected from a gain codebook.

The method provided in the first aspect may further include: transmitting an encoding parameter. The encoding parameter may include: the frame classification parameter index of the current frame and an index of the winning codebook vector in the gain codebook.

According to a second aspect, compared with the method for encoding a sound signal in the first aspect, a method for decoding a sound signal is provided, similarly applied to a first subframe in a current frame. The method may include: receiving an encoding parameter, where the encoding parameter may include: a frame classification parameter index of the current frame and an index of a winning codebook vector, searching a first mapping table for a linear estimated value of an algebraic codebook gain in a linear domain based on the frame classification parameter index of the current frame, where each entry in the first mapping table includes two values: a frame classification parameter index and a linear estimated value of an algebraic codebook gain in the linear domain, calculating energy of an algebraic codebook vector from an algebraic codebook, dividing the linear estimated value of the algebraic codebook gain in the linear domain by a square root of the energy of the algebraic codebook vector, to obtain an estimated gain of the algebraic codebook, and finally multiplying the estimated gain of the algebraic codebook by a correction factor, to obtain a quantized gain of the algebraic codebook, where the correction factor is from the winning codebook vector, and the winning codebook vector is selected from a gain codebook based on the index of the winning codebook vector.

The methods provided in the first aspect and the second aspect have at least the following beneficial effects: when the estimated gain of the algebraic codebook in the first subframe is calculated during encoding and decoding, operations with high complexity such as a logarithm log operation and an exponential operation with 10 as a base can be completely avoided, thereby significantly reducing algorithm complexity. In addition, a codec may directly obtain a value of 10^{a}^{₀}^{+a}^{₁}^{CT} corresponding to a parameter CT of the current frame through table lookup, to avoid a case that calculation is performed when the codec runs, thereby reducing the algorithm complexity.

According to a third aspect, a method for encoding a sound signal is provided, applied to a first subframe in a current frame. The method may include: receiving a frame classification parameter index of the current frame, searching a first mapping table for a linear estimated value of an algebraic codebook gain in a logarithm domain according to the frame classification parameter index of the current frame, where each entry in the first mapping table includes two values: a frame classification parameter index and a linear estimated value of an algebraic codebook gain in the logarithm domain, converting the linear estimated value of the algebraic codebook gain in the logarithm domain into a linear domain through an exponential operation, to obtain a linear estimated value of the algebraic codebook gain in the linear domain, calculating energy of an algebraic codebook vector from an algebraic codebook, dividing the linear estimated value of the algebraic codebook gain in the linear domain by a square root of the energy of the algebraic codebook vector, to obtain an estimated gain of the algebraic codebook, and finally multiplying the estimated gain of the algebraic codebook by a correction factor, to obtain a quantized gain of the algebraic codebook, where the correction factor is from a winning codebook vector, and the winning codebook vector is selected from a gain codebook.

The method provided in the third aspect may further include: transmitting an encoding parameter, where the encoding parameter includes: the frame classification parameter index of the current frame and an index of the winning codebook vector in the gain codebook.

According to a fourth aspect, compared with the method for encoding a sound signal in the third aspect, a method for decoding a sound signal is provided, similarly applied to a first subframe in a current frame. The method may include: receiving an encoding parameter, where the encoding parameter includes: a frame type of the current frame, a linear estimation constant in the first subframe, and an index of a winning codebook vector; performing linear estimation by using the linear estimation constant in the first subframe and the frame type of the current frame, to obtain a linear estimated value of an algebraic codebook gain in a logarithm domain; converting the linear estimated value of the algebraic codebook gain in the logarithm domain into a linear domain through an exponential operation, to obtain a linear estimated value of the algebraic codebook gain in the linear domain; calculating energy of an algebraic codebook vector from an algebraic codebook; dividing the linear estimated value of the algebraic codebook gain in the linear domain by a square root of the energy of the algebraic codebook vector, to obtain an estimated gain of the algebraic codebook; and multiplying the estimated gain of the algebraic codebook by a correction factor, to obtain a quantized gain of the algebraic codebook, where the correction factor is from the winning codebook vector, and the winning codebook vector is selected from a gain codebook based on the index of the winning codebook vector.

The methods provided in the third aspect and the fourth aspect have at least the following beneficial effects: when the estimated gain of the algebraic codebook in the first subframe is calculated during encoding and decoding, a logarithm operation and an exponential operation involved in the energy Ec of the algebraic codebook vector can be avoided, thereby reducing algorithm complexity. In addition, a codec may directly obtain a value of a₀+a₁CT corresponding to a parameter CT of the current frame through table lookup, to avoid a case that the value is calculated when the codec runs, thereby reducing a calculation amount.

According to a fifth aspect, a method for encoding a sound signal is provided, applied to a first subframe in a current frame. The method may include: performing linear estimation by using a linear estimation constant in the first subframe and a frame type of the current frame, to obtain a linear estimated value of an algebraic codebook gain in a logarithm domain; converting the linear estimated value of the algebraic codebook gain in the logarithm domain into a linear domain through an exponential operation, to obtain a linear estimated value of the algebraic codebook gain in the linear domain; calculating energy of an algebraic codebook vector from an algebraic codebook; dividing the linear estimated value of the algebraic codebook gain in the linear domain by a square root of the energy of the algebraic codebook vector, to obtain an estimated gain of the algebraic codebook; and multiplying the estimated gain of the algebraic codebook by a correction factor, to obtain a quantized gain of the algebraic codebook, where the correction factor is from a winning codebook vector, and the winning codebook vector is selected from a gain codebook.

The method provided in the fifth aspect may further include: transmitting an encoding parameter, where the encoding parameter includes: the frame type of the current frame, the linear estimation constant, and an index of the winning codebook vector in the gain codebook.

According to a sixth aspect, compared with the method for encoding a sound signal in the fifth aspect, a method for decoding a sound signal is provided, similarly applied to a first subframe in a current frame. The method may include: receiving an encoding parameter, where the encoding parameter includes: a frame type of the current frame, a linear estimation constant in the first subframe, and an index of a winning codebook vector; performing linear estimation by using the linear estimation constant in the first subframe and the frame type of the current frame, to obtain a linear estimated value of an algebraic codebook gain in a logarithm domain; converting the linear estimated value of the algebraic codebook gain in the logarithm domain into a linear domain through an exponential operation, to obtain a linear estimated value of the algebraic codebook gain in the linear domain; calculating energy of an algebraic codebook vector from an algebraic codebook; dividing the linear estimated value of the algebraic codebook gain in the linear domain by a square root of the energy of the algebraic codebook vector, to obtain an estimated gain of the algebraic codebook; and multiplying the estimated gain of the algebraic codebook by a correction factor, to obtain a quantized gain of the algebraic codebook, where the correction factor is from the winning codebook vector, and the winning codebook vector is selected from a gain codebook based on the index of the winning codebook vector.

The methods provided in the fifth aspect and the sixth aspect have at least the following beneficial effects: when the estimated gain of the algebraic codebook of the first subframe is calculated during encoding and decoding, a logarithm operation and an exponential operation involved in the energy Ec of the algebraic codebook vector can be avoided, thereby reducing algorithm complexity.

According to a seventh aspect, a method for encoding a sound signal is provided, applied to a first subframe in a current frame. The method may include: receiving a frame classification parameter index of the current frame; searching a first mapping table for a linear estimated value of an algebraic codebook gain in a linear domain according to the frame classification parameter index of the current frame, where each entry in the first mapping table includes two values: a frame classification parameter index and a linear estimated value of an algebraic codebook gain in the linear domain; calculating energy Ec of an algebraic codebook vector from an algebraic codebook, performing a logarithm operation with 10 as a base on a square root of the energy, calculating an additive inverse of a value obtained through the logarithm operation, and then performing an exponential operation with 10 as a base, to obtain 10^{-log}^{₁₀}⁽{square root over (^{E}^{_{c}}⁾)}; multiplying the linear estimated value of the algebraic codebook gain in the linear domain by 10^{-log}^{₁₀}⁽{square root over (^{E}^{_{c}}⁾)}, to obtain an estimated gain of the algebraic codebook; and multiplying the estimated gain g_{c0}^{[0]} of the algebraic codebook by a correction factor, to obtain a quantized gain of the algebraic codebook gain, where the correction factor is from a winning codebook vector, and the winning codebook vector is selected from a gain codebook.

The method provided in the seventh aspect may further include: transmitting an encoding parameter, where the encoding parameter includes: the frame classification parameter index of the current frame and an index of the winning codebook vector in the gain codebook.

According to an eighth aspect, compared with the method for encoding a sound signal in the seventh aspect, a method for decoding a sound signal is provided, similarly applied to a first subframe in a current frame. The method may include: receiving an encoding parameter, where the encoding parameter includes: a frame classification parameter index of the current frame and an index of a winning codebook vector; searching a first mapping table for a linear estimated value of an algebraic codebook gain in a linear domain according to the frame classification parameter index of the current frame, where each entry in the first mapping table includes two values: a frame classification parameter index and a linear estimated value of an algebraic codebook gain in the linear domain; calculating energy Ec of an algebraic codebook vector from an algebraic codebook, performing a logarithm operation with 10 as a base on a square root of the energy, calculating an additive inverse of a value obtained through the logarithm operation, and then performing an exponential operation with 10 as a base, to obtain 10^{-log}^{₁₀}⁽{square root over (^{E}^{_{c}}⁾)}; multiplying the linear estimated value of the algebraic codebook gain in the linear domain by 10^{-log}^{₁₀}⁽{square root over (^{E}^{_{c}}⁾)}, to obtain an estimated gain of the algebraic codebook; and multiplying the estimated gain g_{c0}^{[0]} of the algebraic codebook by a correction factor, to obtain a quantized gain of the algebraic codebook gain, where the correction factor is from the winning codebook vector, and the winning codebook vector is selected from a gain codebook based on the index of the winning codebook vector.

The methods provided in the seventh aspect and the eighth aspect have at least the following beneficial effects: a codec may directly obtain a value of 10^{a}^{₀}^{+a}^{₁}^{CT} corresponding to a parameter CT of the current frame through table lookup, to avoid an exponential operation with 10 as a base involved in the linear estimated value of the algebraic codebook gain, thereby reducing algorithm complexity.

The methods for encoding and decoding a sound signal provided in the first aspect to the eighth aspect may further include: multiplying the quantized gain of the algebraic codebook gain by the algebraic codebook vector from the algebraic codebook, to obtain an excitation contribution of the algebraic codebook; multiplying a quantized gain of an adaptive codebook included in the winning codebook vector selected from the gain codebook by an adaptive codebook vector from the adaptive codebook, to obtain an excitation contribution of the adaptive codebook; and finally, adding up the excitation contribution of the algebraic codebook and the excitation contribution of the adaptive codebook, to obtain total excitation. The total excitation may reconstruct a voice signal through a synthesis filter.

According to a ninth aspect, an apparatus having a voice encoding function is provided and may be configured to implement the method provided in the first aspect. The apparatus may include: a searching component such as a table lookup module 601 shown in FIG. 6, configured to search a first mapping table for a linear estimated value of an algebraic codebook gain in a linear domain according to a frame classification parameter index of a current frame, where each entry in the first mapping table includes two values: a frame classification parameter index and a linear estimated value of an algebraic codebook gain in the linear domain; a first calculator, including a square summator 603 and a square root calculator 604 shown in FIG. 6 and configured to calculate energy of an algebraic codebook vector from an algebraic codebook; a first multiplier such as a multiplier 602 shown in FIG. 6, configured to multiply the linear estimated value of the algebraic codebook gain in the linear domain by a reciprocal of a square root of the energy of the algebraic codebook vector, to obtain an estimated gain of the algebraic codebook; and a second multiplier such as a multiplier 605 shown in FIG. 6, configured to multiply the estimated gain of the algebraic codebook by a correction factor included in a winning codebook vector, to obtain a quantized gain of the algebraic codebook, where the winning codebook vector is selected from a gain codebook.

The apparatus provided in the ninth aspect may further include: a communication component, configured to transmit an encoding parameter, where the encoding parameter includes: the frame classification parameter index of the current frame and an index of the winning codebook vector in the gain codebook.

According to a tenth aspect, an apparatus having a voice decoding function is provided and may be configured to implement the method provided in the second aspect. The apparatus may include: a communication component, configured to receive an encoding parameter, where the encoding parameter includes: a frame classification parameter index of a current frame and an index of a winning codebook vector; a first searching component such as a table lookup module 601 shown in FIG. 6, configured to search a first mapping table for a linear estimated value of an algebraic codebook gain in a linear domain based on the frame classification parameter index of the current frame, where each entry in the first mapping table includes two values: a frame classification parameter index and a linear estimated value of an algebraic codebook gain in the linear domain; a first calculator, including a square summator 603 and a square root calculator 604 shown in FIG. 6 and configured to calculate energy of an algebraic codebook vector from an algebraic codebook; a first multiplier such as a multiplier 602 shown in FIG. 6, configured to multiply the linear estimated value of the algebraic codebook gain in the linear domain by a reciprocal of a square root of the energy of the algebraic codebook vector, to obtain an estimated gain of the algebraic codebook; a second multiplier such as a multiplier 605 shown in FIG. 6, configured to multiply the estimated gain of the algebraic codebook by a correction factor, to obtain a quantized gain of the algebraic codebook, where the correction factor is from the winning codebook vector; and a second searching component, configured to search a gain codebook for the winning codebook vector based on the index of the winning codebook vector.

According to an eleventh aspect, an apparatus having a voice encoding function is provided and may be configured to implement the method provided in the third aspect. The apparatus may include: a searching component such as a table lookup module 701 shown in FIG. 7, configured to search a first mapping table for a linear estimated value of an algebraic codebook gain in a logarithm domain according to a frame classification parameter index of a current frame, where each entry in the first mapping table includes two values: a frame classification parameter index and a linear estimated value of an algebraic codebook gain in the logarithm domain; a converter such as an exponential calculator 702 shown in FIG. 7, configured to convert the linear estimated value of the algebraic codebook gain in the logarithm domain into a linear domain through an exponential operation, to obtain a linear estimated value of the algebraic codebook gain in the linear domain; a first calculator, including a square summator 704 and a square root calculator 705 shown in FIG. 7 and configured to calculate energy of an algebraic codebook vector from an algebraic codebook; a first multiplier such as a multiplier 703 shown in FIG. 7, configured to multiply the linear estimated value of the algebraic codebook gain in the linear domain by a reciprocal of a square root of the energy of the algebraic codebook vector, to obtain an estimated gain of the algebraic codebook; and a second multiplier such as a multiplier 707 shown in FIG. 7, configured to multiply the estimated gain of the algebraic codebook by a correction factor included in a winning codebook vector, to obtain a quantized gain of the algebraic codebook, where the winning codebook vector is selected from a gain codebook.

The apparatus provided in the eleventh aspect may further include: a communication component, configured to transmit an encoding parameter, where the encoding parameter includes: the frame classification parameter index of the current frame and an index of the winning codebook vector in the gain codebook.

According to a twelfth aspect, an apparatus having a voice decoding function is provided and may be configured to implement the method provided in the fourth aspect. The apparatus may include: a communication component, configured to receive an encoding parameter, where the encoding parameter includes: a frame classification parameter index of a current frame and an index of a winning codebook vector; a first searching component such as a table lookup module 701 shown in FIG. 7, configured to search a first mapping table for a linear estimated value of an algebraic codebook gain in a logarithm domain based on the frame classification parameter index of the current frame, where each entry in the first mapping table includes two values: a frame classification parameter index and a linear estimated value of an algebraic codebook gain in the logarithm domain; a converter such as an exponential calculator 702 shown in FIG. 7, configured to convert the linear estimated value of the algebraic codebook gain in the logarithm domain into a linear domain through an exponential operation, to obtain a linear estimated value of the algebraic codebook gain in the linear domain;
a first calculator, including a square summator 704 and a square root calculator 705 shown in FIG. 7 and configured to calculate energy of an algebraic codebook vector from an algebraic codebook; a first multiplier such as a multiplier 703 shown in FIG. 7, configured to multiply the linear estimated value of the algebraic codebook gain in the linear domain by a reciprocal of a square root of the energy of the algebraic codebook vector, to obtain an estimated gain of the algebraic codebook; and a second multiplier such as a multiplier 707 shown in FIG. 7, configured to multiply the estimated gain of the algebraic codebook by a correction factor, to obtain a quantized gain of the algebraic codebook, where the correction factor is from the winning codebook vector; and a second searching component, configured to search a gain codebook for the winning codebook vector based on the index of the winning codebook vector.

According to a thirteenth aspect, an apparatus having a voice encoding function is provided and may be configured to implement the method provided in the fifth aspect. The apparatus may include: a linear prediction component such as a linear estimation module 801 shown in FIG. 8, configured to perform linear estimation by using a linear estimation constant in a first subframe and a frame type of a current frame, to obtain a linear estimated value of an algebraic codebook gain in a logarithm domain; a converter such as an exponential calculator 802 shown in FIG. 8, configured to convert the linear estimated value of the algebraic codebook gain in the logarithm domain into a linear domain through an exponential operation, to obtain a linear estimated value of the algebraic codebook gain in the linear domain; a first calculator, including a square summator 804 and a square root calculator 805 shown in FIG. 8 and configured to calculate energy of an algebraic codebook vector from an algebraic codebook; a first multiplier such as a multiplier 803 shown in FIG. 8, configured to multiply the linear estimated value of the algebraic codebook gain in the linear domain by a reciprocal of a square root of the energy of the algebraic codebook vector, to obtain an estimated gain of the algebraic codebook; and a second multiplier such as a multiplier 806 shown in FIG. 8, configured to multiply the estimated gain of the algebraic codebook by a correction factor included in a winning codebook vector, to obtain a quantized gain of the algebraic codebook, where the winning codebook vector is selected from a gain codebook.

The apparatus provided in the thirteenth aspect may further include: a communication component, configured to transmit an encoding parameter, where the encoding parameter includes: the frame type of the current frame, the linear estimation constant, and an index of the winning codebook vector in the gain codebook.

According to a fourteenth aspect, an apparatus having a voice decoding function is provided and may be configured to implement the method provided in the sixth aspect. The apparatus may include: a communication component, configured to receive an encoding parameter, where the encoding parameter includes: a frame type of a current frame, a linear estimation constant in a first subframe, and an index of a winning codebook vector; a linear prediction component such as a linear estimation module 801 shown in FIG. 8, configured to perform linear estimation by using the linear estimation constant in the first subframe and the frame type of the current frame, to obtain a linear estimated value of an algebraic codebook gain in a logarithm domain; a converter such as an exponential calculator 802 shown in FIG. 8, configured to convert the linear estimated value of the algebraic codebook gain in the logarithm domain into a linear domain through an exponential operation, to obtain a linear estimated of the algebraic codebook gain in the linear domain; a first calculator, including a square summator 804 and a square root calculator 805 shown in FIG. 8 and configured to calculate energy of an algebraic codebook vector from an algebraic codebook; a first multiplier such as a multiplier 803 shown in FIG. 8, configured to multiply the linear estimated value of the algebraic codebook gain in the linear domain by a reciprocal of a square root of the energy of the algebraic codebook vector, to obtain an estimated gain of the algebraic codebook; and a second multiplier such as a multiplier 806 shown in FIG. 8, configured to multiply the estimated gain of the algebraic codebook by a correction factor, to obtain a quantized gain of the algebraic codebook, where the correction factor is from the winning codebook vector; and a searching component, configured to search a gain codebook for the winning codebook vector based on the index of the winning codebook vector.

According to a fifteenth aspect, an apparatus having a voice encoding function is provided and may be configured to implement the method provided in the seventh aspect. The apparatus may include: a first searching component such as a table lookup module 901 shown in FIG. 9, configured to search a first mapping table for a linear estimated value of an algebraic codebook gain in a linear domain according to a frame classification parameter index of a current frame, where each entry in the first mapping table includes two values: a frame classification parameter index and a linear estimated value of an algebraic codebook gain in the linear domain; a first calculator, including a square summator 903 and a square root calculator 904 shown in FIG. 9 and configured to calculate energy Ec of an algebraic codebook vector from an algebraic codebook; a logarithm operator such as a calculator 905 shown in FIG. 9, configured to perform a logarithm operation with 10 as a base on a square root of the energy; an exponential operator such as a calculator 906 shown in FIG. 9, configured to calculate an additive inverse of a value obtained through the logarithm operation, and then perform an exponential operation with 10 as a base, to obtain 10^{-log}^{₁₀}⁽{square root over (^{E}^{_{c}}⁾)}; a first multiplier such as a multiplier 902 shown in FIG. 9, configured to multiply the linear estimated value of the algebraic codebook gain in the linear domain by 10^{-log}^{₁₀}⁽{square root over (^{E}^{_{c}}⁾)}, to obtain an estimated gain of the algebraic codebook; and a second multiplier such as a multiplier 907 shown in FIG. 9, configured to multiply the estimated gain g_{c0}^{[0]} of the algebraic codebook by a correction factor, to obtain a quantized gain of the algebraic codebook gain, where the correction factor is from a winning codebook vector, and the winning codebook vector is selected from a gain codebook.

The apparatus provided in the fifteenth aspect may further include: a communication component, configured to transmit an encoding parameter, where the encoding parameter includes: the frame classification parameter index of the current frame and an index of the winning codebook vector in the gain codebook.

According to a sixteenth aspect, an apparatus having a voice decoding function is provided and may be configured to implement the method provided in the eighth aspect. The apparatus may include: a communication component, configured to receive an encoding parameter, where the encoding parameter may include: a frame classification parameter index of a current frame and an index of a winning codebook vector in a gain codebook; a first searching component such as a table lookup module 901 shown in FIG. 9, configured to search a first mapping table for a linear estimated value of an algebraic codebook gain in a linear domain according to the frame classification parameter index of the current frame, where each entry in the first mapping table includes two values: a frame classification parameter index and a linear estimated value of an algebraic codebook gain in the linear domain; a first calculator, including a square summator 903 and a square root calculator 904 shown in FIG. 9 and configured to calculate energy Ec of an algebraic codebook vector from an algebraic codebook; a logarithm operator such as a calculator 905 shown in FIG. 9, configured to perform a logarithm operation with 10 as a base on a square root of the energy; an exponential operator such as a calculator 906 shown in FIG. 9, configured to calculate an additive inverse of a value obtained through the logarithm operation, and then perform an exponential operation with 10 as a base, to obtain 10^{-log}^{₁₀}⁽{square root over (^{E}^{_{c}}⁾)}; a first multiplier such as a multiplier 902 shown in FIG. 9, configured to multiply the linear estimated value of the algebraic codebook gain in the linear domain by 10^{-log}^{₁₀}⁽{square root over (^{E}^{_{c}}⁾)}, to obtain an estimated gain of the algebraic codebook; and a second multiplier such as a multiplier 907 shown in FIG. 9, configured to multiply the estimated gain g_{c0}^{[0]} of the algebraic codebook by a correction factor, to obtain a quantized gain of the algebraic codebook gain, where the correction factor is from the winning codebook vector; and a second searching component, configured to search a gain codebook for the winning codebook vector based on the index of the winning codebook vector.

The apparatuses having a voice encoding function and a voice decoding function provided in the ninth aspect to the sixteenth aspect may further include:
a third multiplier, configured to multiply the quantized gain of the algebraic codebook gain by the algebraic codebook vector from the algebraic codebook, to obtain an excitation contribution of the algebraic codebook;
a fourth multiplier, configured to multiply a quantized gain of an adaptive codebook included in the winning codebook vector selected from the gain codebook by an adaptive codebook vector from the adaptive codebook, to obtain an excitation contribution of the adaptive codebook; and
an adder, configured to add up the excitation contribution of the algebraic codebook and the excitation contribution of the adaptive codebook, to obtain total excitation.

According to a seventeenth aspect, a voice communication system is provided and may include: a first apparatus and a second apparatus, where the first apparatus may be configured to perform the methods for encoding a sound signal provided in the first aspect, the third aspect, the fifth aspect, and the seventh aspect, and the second apparatus may be configured to perform the methods for encoding a sound signal provided in the second aspect, the fourth aspect, the sixth aspect, and the eighth aspect. The first apparatus may be the apparatus having a voice encoding function provided in the ninth aspect, the eleventh aspect, the thirteenth aspect, and the fifteenth aspect, and the second apparatus may be the apparatus having a voice decoding function provided in the tenth aspect, the twelfth aspect, the fourteenth aspect, and the sixteenth aspect.

### BRIEF DESCRIPTION OF THE DRAWINGS

To describe the technical solutions in embodiments of this application more clearly, the following describes the accompanying drawings required in embodiments of this application.

FIG. 1 is a block diagram of an existing CELP encoding algorithm;

FIG. 2 is a block diagram of an existing CELP decoding algorithm;

FIG. 3 is a gain quantization process in an encoder of memory-less joint gain coding;

FIG. 4 is a process of calculating an algebraic codebook gain in a first subframe;

FIG. 5 is a process of calculating an algebraic codebook gain in a second subframe and a subsequent subframe;

FIG. 6 is a process of calculating an algebraic codebook gain in a first subframe according to Embodiment 1 of this application;

FIG. 7 is a process of calculating an algebraic codebook gain in a first subframe according to Embodiment 2 of this application;

FIG. 8 is a process of calculating an algebraic codebook gain in a first subframe according to Embodiment 3 of this application;

FIG. 9 is a process of calculating an algebraic codebook gain in a first subframe according to Embodiment 4 of this application;

FIG. 10 is a process of designing a gain codebook by using a calculated estimation constant; and

FIG. 11 shows a voice communication system including a voice encoding apparatus and a voice decoding apparatus according to an embodiment of this application.

### DETAILED DESCRIPTION OF THE EMBODIMENTS

In embodiments of this application, a related art of CELP encoding and decoding is improved, which can implement memory-less joint gain coding and also reduce complexity of calculating a codebook gain.

### Existing CELP Encoding and Decoding Technologies

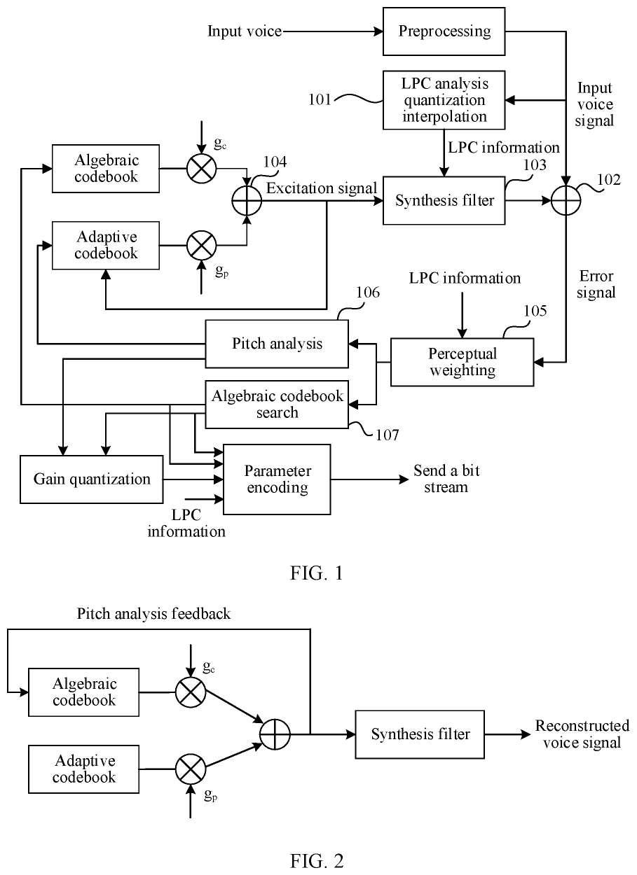

FIG. 1 is a block diagram of an existing CELP encoding algorithm.

An input voice signal is first preprocessed. During preprocessing, sampling, pre-emphasis, and the like may be performed on the input voice signal. A preprocessed signal is further output to an LPC analysis quantization interpolation module 101 and an adder 102. The LPC analysis quantization interpolation module 101 performs linear predictive analysis on the input voice signal, performs quantization and interpolation on an analysis result, and calculates a linear predictive coding (linear predictive coding, LPC) parameter. The LPC parameter is used for constructing a synthesis filter (synthesis filter) 103. Both a result obtained by multiplying an algebraic codebook vector from an algebraic codebook by an algebraic codebook gain g_{c} and a result obtained by multiplying an adaptive codebook vector from an adaptive codebook by an adaptive codebook gain gₚ are output to an adder 104 for adding up, and an adding result is output to the synthesis filter 103, to construct a reconstructed voice signal generated after an excitation signal is processed through the synthesis filter 103. The reconstructed voice signal is also output to the adder 102 and is subtracted from the input voice signal to obtain an error signal.

The error signal is processed by a perceptual weighting (perceptual weighting) filter 105 to change a spectrum according to hearing experience, and is fed back to a pitch analysis (pitch analysis) module 106 and an algebraic codebook search (algebra codebook search) module 107. The perceptual weighting filter 105 is also constructed based on the LPC parameter.

An excitation signal and a codebook gain are determined according to a principle of minimizing a mean square error of the perceptual weighted error signal. The pitch analysis module 106 derives a pitch period through autocorrelation analysis, searches an adaptive codebook based on the pitch period to determine an optimal adaptive codebook vector, and obtains an excitation signal with a quasi-periodic feature in voice. The algebraic codebook search module 107 searches an algebraic codebook, determines an optimal algebraic codebook vector according to a principle of minimizing a weighted mean square error, and obtains a random excitation signal of a voice model. Then, a gain of the optimal adaptive codebook vector and a gain of the optimal algebraic codebook vector are determined. Encoding parameters such as a quantized gain of a codebook, an index of the optimal adaptive codebook vector in the adaptive codebook, an index of the optimal algebraic codebook vector in the algebraic codebook, and a linear predictive coding parameter form a bit stream, and the bit stream is transmitted to a decoding side.

FIG. 2 is a block diagram of an existing CELP decoding algorithm.

First, the decoding side obtains each encoding parameter from a compressed bit stream. Then, the decoding side generates an excitation signal by using the encoding parameters. The following processing is performed on each subframe: multiplying the adaptive codebook vector and the algebraic codebook vector by respective quantized gains to obtain excitation signals; and obtaining a reconstructed voice signal after the excitation signals are processed through a linear prediction synthesis filter 201. On the decoding side, the linear prediction synthesis filter 201 is also constructed based on the LPC parameter.

### Memory-Less Joint Gain Coding (Memory-Less Joint Gain Coding)

Further, memory-less joint gain coding may be performed on an adaptive codebook gain and an algebraic codebook gain in each subframe, especially at a low bit rate (for example, 7.2 kbps or 8 kbps). After the joint gain coding is performed, an index of a quantized gain gₚ of an adaptive codebook in a gain codebook (gain codebook) is transmitted together with a bit stream.

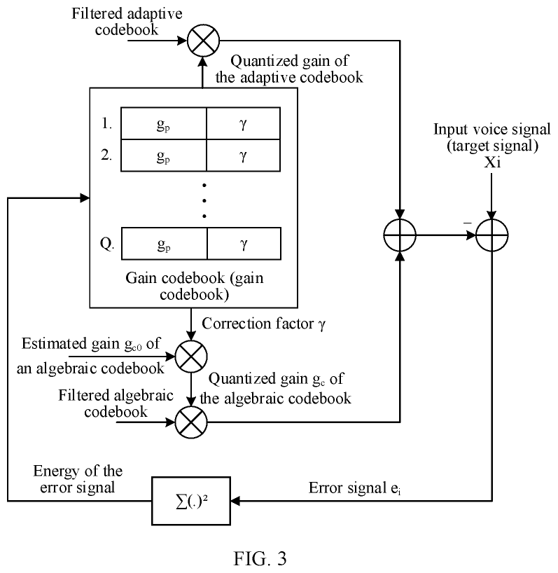

Before a gain quantization process, it is assumed that an adaptive codebook and an algebraic codebook that are filtered are already known. Gain quantization in an encoder is implemented by searching a designed gain codebook based on a principle of a minimum mean square error MMSE. Each entry in the gain codebook includes two values: a quantized gain gₚ of an adaptive codebook and a correction factor γ used for an algebraic codebook gain. Estimation of the algebraic codebook gain is completed in advance, and a result g_{c0} is multiplied by a correction factor γ selected from the gain codebook. In each subframe, the gain codebook is completely searched, for example, an index q=0, . . . , Q−1. If a quantized gain of an adaptive part of excitation is forced to be less than a specific threshold, it is possible to limit a search range. To allow the search range to be reduced, codebook entries in the gain codebook may be arranged in ascending order according to values of gₚ. The gain quantization process may be shown in FIG. 3.

The gain quantization is implemented by minimizing energy of an error signal e(i). Error energy is represented by using the following formula:

E=e^{T}e=(x−gₚy−g_{c}z)^{T}(x−gₚy−g_{c}z) formula (1)

g_{c} is replaced by γ*g_{c0}, and the formula may be expanded into:

E=c₅+gₚ²c₀−2gₚc₁+γ²gₚ²c₀−2γg_{c0}c₃+2gₚγg_{c0}c₄ formula (2)

Constants c₀, c₁, c₂, c₃, c₄, and c₅ and an estimated gain g_{c0} are calculated before the gain codebook is searched. The error energy E is calculated for each codebook entry. A codebook vector [gₚ; γ] causing minimum error energy is selected as a winning codebook vector, and an entry of the codebook vector corresponds to the quantized gain gₚ of the adaptive codebook and γ.

Then, a quantized gain g_{c} of a fixed codebook may be calculated as follows:

$${g}_{c} = {g}_{c 0} * γ \qquad formula ( 3 )$$

In a decoder, a received index is used for obtaining a quantized gain gₚ of adaptive excitation and a quantization correction factor γ of an estimated gain of algebraic excitation. In the encoder, an estimated gain of an algebraic part of excitation is completed in a same manner.

In a first subframe of a current frame, an estimated (predicted) gain of an algebraic codebook is given by using the following formula (4):

$${g}_{c 0}^{[ 0 ]} = 1 {0}^{{a}_{0} + {a}_{1} CT - {log}_{10} ( \sqrt{{E}_{c}} )} \qquad formula ( 4 )$$

CT is an encoding classification (encoding mode) parameter and is a type selected for the current frame in a preprocessing part of the encoder. Ec is energy of a filtered algebraic codebook vector with a unit of dB and is calculated by using the following formula (5). Estimation constants a₀ and a₁ are determined by minimizing an MSE on a big signal database. The encoding mode parameter CT in the formula is constant for all subframes of the current frame. A superscript [0] represents the first subframe of the current frame.

$${E}_{c} = 10 log ( \frac{1}{64} {\sum }_{0}^{63} {c}^{2} ( n ) ) \qquad formula ( 5 )$$

c(n) is a filtered algebraic code vector.

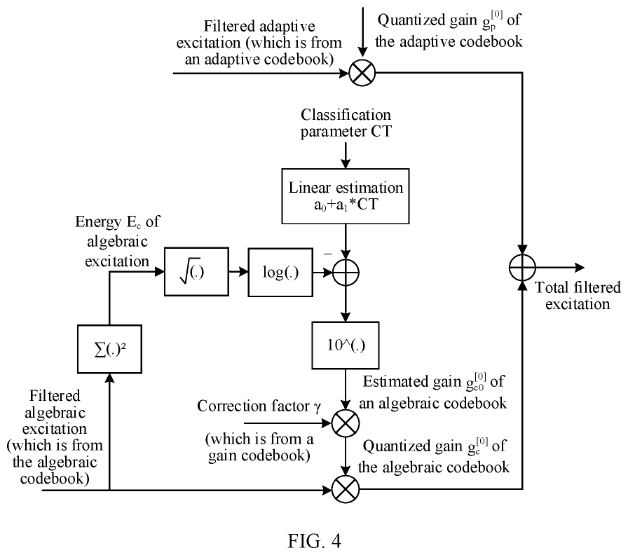

FIG. 4 is a gain estimation process of a first subframe.

An algebraic codebook gain estimation process is described as follows. An algebraic codebook gain is estimated according to a classification parameter CT of a current frame, and energy of an algebraic code vector from an algebraic codebook has been excluded from the estimated algebraic codebook gain. Finally, an estimated gain of the algebraic codebook is multiplied by a correction factor γ selected from the gain codebook, to obtain a quantized algebraic codebook gain g_{c}.

Specifically, as shown in FIG. 4, linear estimation is first performed on the algebraic codebook gain according to the classification parameter CT in a logarithm domain, to obtain a linear estimated value of the algebraic codebook gain: a₀+a₁CT. Then, an energy parameter log₁₀ \sqrt{E_{c}} of the algebraic codebook vector from the algebraic codebook is subtracted from the linear estimated value, to obtain an estimated gain of the algebraic codebook in the logarithm domain: a₀+a₁CT−log₁₀ \sqrt{E_{c}}, where Ec is obtained by using the foregoing formula (5). Then, the estimated gain of the algebraic codebook in the logarithm domain is converted into a linear domain, to obtain an estimated gain g_{c0}^{[0]} of the algebraic codebook in the linear domain, which refers to the foregoing formula (4). Finally, the estimated gain g_{c0}^{[0]} of the algebraic codebook is multiplied by the correction factor γ selected from the gain codebook, to obtain the quantized algebraic codebook gain g_{c}^{[0]}.

A quantized gain gₚ^{[0]} of the adaptive codebook is directly selected from the gain codebook. Specifically, the gain codebook is searched based on a principle of minimum mean square error MMSE, which refers to the foregoing formula (2).

All subframes after the first subframe of the current frame use slightly different estimation solutions. A differences lies in that in the subframes, both quantized gains of an adaptive codebook and an algebraic codebook from a previous subframe are used as auxiliary estimation parameters to improve efficiency. In a k^{th} subframe, where k>0, an estimated gain of an algebraic codebook is given by using the following formula (6):

$${g}_{c 0}^{[ k ]} = 1 {0}^{{b}_{0} + {b}_{1} CT + {{\sum }^{k}}_{i = 1} {b}_{i + 1} {log}_{10} ( {g}_{c}^{[ i - 1 ]} ) + {{\sum }^{k}}_{i = 1} {b}_{k + 1 + i} {g}_{p}^{[ i - 1 ]}} \qquad formula ( 6 )$$

k=1, 2, 3. A first sum term Y and a second sum term Σ in an exponential respectively represent a quantized gain of an algebraic codebook and a quantized gain of an adaptive codebook of a previous subframe. Estimation constants b₀, . . . , and b₂ₖ₊₁ are also determined by minimizing the MSE on the big signal database.

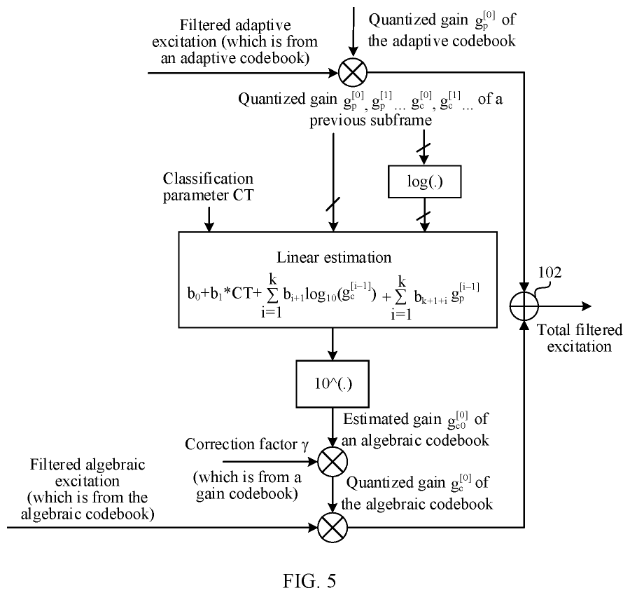

FIG. 5 is a gain estimation process of a second subframe and a subsequent subframe. Different from the first frame, in addition to the classification parameter CT of the current frame, an algebraic codebook gain of a latter subframe is further estimated according to quantized gains of an adaptive codebook and an algebraic codebook of a former subframe.

Specifically, as shown in FIG. 5, an estimated gain of an algebraic codebook is first calculated in a logarithm domain: b₀+b₁CT+Σᵢ₌^{k}bᵢ₊₁ log₁₀ (g_{c}^{[i-1]})+Σᵢ₌₁^{k}bₖ₊₁₊ᵢgₚ^{[i-1]}, that is, an exponential term in the formula (6). Then, the estimated gain of the algebraic codebook in the logarithm domain is converted into a linear domain. Finally, an algebraic codebook gain estimated in the linear domain is multiplied by the correction factor γ selected from the gain codebook, to form a quantized algebraic codebook gain g_{c}^{[k]}.

In a second subframe and a subsequent subframe, a quantized gain g_{c}^{[k]} of an adaptive codebook is also directly selected from the gain codebook.

A difference between an estimation process of the second subframe and the subsequent subframe and the estimation process of the first subframe also lies in that energy of an algebraic codebook vector from an algebraic codebook is not subtracted from the estimated gain of the algebraic codebook in the logarithm domain. This is because gain estimation of a latter subframe is based on an algebraic codebook gain of a former subframe, the energy is already subtracted from the algebraic codebook gain of the previous first subframe, and the gain estimation of the latter subframe does not need to consider an impact of removing the energy.

For memory-loss joint gain coding, reference may be further made to the following document: 3GPP TS26.445, “Codec for Enhanced Voice Services (EVS); Detailed algorithmic description”, which is incorporated herein by reference in its entirety.

In the decoder, a winning codebook vector [gₚ; γ] causing minimum error energy is found from the gain codebook according to an index, where gₚ is the quantized gain of the adaptive codebook, and a quantized gain g_{c} of the algebraic codebook is obtained by multiplying an estimated gain g_{c0} of the algebraic codebook by the correction factor γ. A calculation manner of gₑ₀ is the same as a manner used in the encoder. An adaptive codebook vector and an algebraic codebook vector are obtained through decoding from a bit stream, and the adaptive codebook vector and the algebraic codebook vector are respectively multiplied by the quantized gains of the adaptive codebook and the algebraic codebook, to obtain an adaptive excitation contribution and an algebraic excitation contribution. Finally, the two excitation contributions are added up to form total excitation, and the linear prediction synthesis filter filters the total excitation to reconstruct a voice signal.

The related art of CELP encoding and decoding has a problem of relatively high calculation complexity. For example, in the formula (4), estimating the algebraic codebook gain in the first subframe requires both a logarithm log operation and an exponential operation with 10 as a base with a relatively large calculation amount.

Therefore, in various embodiments of this application, a process of calculating the algebraic codebook gain in the first subframe is improved, which can reduce high complexity of the logarithmic log operation and the exponential operation with 10 as a base, and reduce calculation complexity of a codebook gain.

### Embodiment 1

In a process of calculating an algebraic codebook gain in a first subframe provided in Embodiment 1, a calculation formula of an estimated gain g_{c0}^{[0]} of an algebraic codebook in the first subframe is optimized as follows, to reduce complexity (which ensures that a calculation result does not change, and an effect is not affected):

$$formula ( 7 )$$

$${g}_{c 0}^{[ 0 ]} = 1 {0}^{{a}_{0} + {a}_{1} CT - {log}_{10} ( \sqrt{{E}_{c}} )} = 1 {0}^{{a}_{0} + {a}_{1} CT} \cdot {10}^{- {log}_{10} ( \sqrt{{E}_{c}} )} = \frac{1 {0}^{{a}_{0} + {a}_{1} CT}}{\sqrt{{E}_{c}}}$$

Because a linear estimated value 10^{a}^{₀}^{+a}^{₁}^{CT} of an algebraic codebook gain in a linear domain is related to only a classification parameter CT and estimation constants a₀ and a₁ in a logarithm domain, a value of 10^{a}^{₀}^{+a}^{₁}^{CT} may be enumerated in a table in advance. 10^{a}^{₀}^{+a}^{₁}^{CT} represents the linear estimated value of the algebraic codebook gain in the linear domain. A codec may maintain a mapping table b. Each entry in the table b includes two values: an index CT_{index} of a classification parameter CT and a linear estimated value 10^{a}^{₀}^{+a}^{₁}^{CT} of an algebraic codebook gain in the linear domain. In this way, the codec may directly obtain a value of 10^{a}^{₀}^{+a}^{₁}^{CT} corresponding to a parameter CT of a current frame through table lookup, to avoid a case that calculation is performed when the codec runs, thereby reducing algorithm complexity.

$$b [ {CT}_{index} ] = 1 {0}^{{a}_{0} + {a}_{1} CT} \qquad formula ( 8 )$$

A calculation process of the formula (7) may be further simplified as:

$${g}_{c 0}^{[ 0 ]} = \frac{b [ {CT}_{index} ]}{\sqrt{{E}_{c}}} \qquad formula ( 9 )$$

A process of calculating an estimated gain of an algebraic codebook in the first subframe represented by the formula (9) may be described as follows. First, a linear estimated value of an algebraic codebook gain in a linear domain is obtained through table lookup according to an index CT_{index} of a classification parameter CT of a current frame. Then, the linear estimated value of the algebraic codebook gain in the linear domain is divided by a square root (which is represented as \sqrt{E_{c}}) of energy E_{c} of an algebraic codebook vector from the algebraic codebook in the linear domain, to obtain the estimated gain g_{c0}^{[0]} of the algebraic codebook in the first subframe. In this way, when the estimated gain of the algebraic codebook in the first subframe is calculated during encoding and decoding, operations with high complexity such as a logarithm log operation and an exponential operation with 10 as a base can be completely avoided, thereby significantly reducing algorithm complexity.

An encoding side may transmit the following encoding parameters to a decoding side: the index CT_{index} of the classification parameter CT of the current frame and an index of a winning codebook vector [gₚ; γ] in a gain codebook.

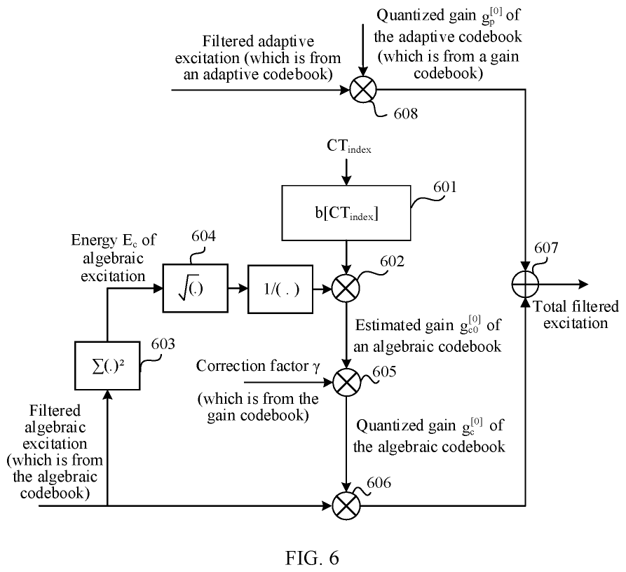

FIG. 6 is a process of calculating an algebraic codebook gain in a first subframe according to Embodiment 1.

As shown in FIG. 6, the index CT_{index} of the classification parameter CT of the current frame is first input to a table lookup module 601. Then, the table lookup module 601 obtains a linear estimated value (which is represented as b[CT_{index}] below) of an algebraic codebook gain in a linear domain through table lookup according to the index CT_{index}, and outputs b[CT_{index}] to a multiplier 602. In addition, a value of a square root \sqrt{E_{c}} of energy of an algebraic codebook vector from an algebraic codebook is sequentially calculated through a square summator 603 and a square root calculator 604. The square summator 603 calculates Ec by using the formula (5), and then outputs a reciprocal value of \sqrt{E_{c}} to the multiplier 602, and b[CT_{index}] is divided by the reciprocal value of \sqrt{E_{c}} to obtain an estimated gain g_{c0}^{[0]} of the algebraic codebook. Then, the estimated gain g_{c0}^{[0]} of the algebraic codebook is output to a multiplier 605, and the estimated gain g_{c0}^{[0]} of the algebraic codebook is multiplied by a correction factor γ from a gain codebook, to obtain a quantized gain g_{c}^{[0]} of the algebraic codebook. The quantized gain g_{c}^{[0]} of the algebraic codebook may be further output to a multiplier 606, and the quantized gain g_{c}^{[0]} of the algebraic codebook is multiplied by the algebraic codebook vector (filtered algebraic excitation) of the algebraic codebook, to obtain an excited algebraic codebook contribution. Finally, the excited algebraic codebook contribution is output to an adder 607, and the excited algebraic codebook contribution and an excited adaptive codebook contribution are added up to obtain total filtered excitation.

The excited adaptive codebook contribution is obtained by multiplying an adaptive codebook vector (filtered adaptive excitation) that is from an adaptive codebook and that is output to a multiplier 608 by a quantized gain g_{c}^{[0]} of the adaptive codebook from the gain codebook. The quantized gain g_{c}^{[0]} of the adaptive codebook is directly selected from the gain codebook. Specifically, the gain codebook is searched based on a principle of minimum mean square error MMSE, which refers to the foregoing formula (2).

### Embodiment 2

In a process of calculating an algebraic codebook gain in a first subframe provided in Embodiment 2, a calculation formula of an estimated gain g_{c0}^{[0]} of an algebraic codebook in the first subframe is optimized as follows (which is the same as the formula (7)), to reduce complexity:

$$formula ( 7 )$$

$${g}_{c 0}^{[ 0 ]} = 1 {0}^{{a}_{0} + {a}_{1} CT - {log}_{10} ( \sqrt{{E}_{c}} )} = 1 {0}^{{a}_{0} + {a}_{1} CT} \cdot {10}^{- {log}_{10} ( \sqrt{{E}_{c}} )} = \frac{1 {0}^{{a}_{0} + {a}_{1} CT}}{\sqrt{{E}_{c}}}$$

A slight difference from Embodiment 1 lies in that only a value of a₀+a₁CT in the formula (7) is enumerated in a table in advance. a₀+a₁CT represents a linear estimated value of an algebraic codebook gain in a logarithm domain. In this case, each entry in a mapping table b maintained by a codec may include two values: an index CT_{index} of a classification parameter CT and a linear estimated value a₀+a₁CT of an algebraic codebook gain in the logarithm domain. In this way, the codec may directly obtain a value of a₀+a₁CT corresponding to a parameter CT of a current frame through table lookup, to avoid a case that the value is calculated when the codec runs, thereby reducing a calculation amount.

$$b [ {CT}_{index} ] = {a}_{0} + {a}_{1} CT \qquad formula ( 10 )$$

A calculation process of the formula (7) may be further simplified as:

$${g}_{c 0}^{[ 0 ]} = \frac{1 {0}^{b [ C {T}_{index} ]}}{\sqrt{{E}_{c}}} \qquad formula ( 11 )$$

A process of calculating an estimated gain of an algebraic codebook in the first subframe represented by the formula (11) may be described as follows. First, a linear estimated value of an algebraic codebook gain in a logarithm domain is obtained through table lookup according to an index CT_{index} of a classification parameter CT of a current frame. Then, a linear estimated value of the algebraic codebook gain in a linear domain is divided by a square root (which is represented as \sqrt{E_{c}}) of energy Ecc of an algebraic codebook vector from the algebraic codebook in the linear domain, to obtain the estimated gain g_{c0}^{[0]} of the algebraic codebook in the first subframe. In this way, when the estimated gain of the algebraic codebook in the first subframe is calculated during encoding and decoding, operations with high complexity such as a logarithm log operation and an exponential operation with 10 as a base can be reduced, thereby significantly reducing algorithm complexity.

An encoding side may transmit the following encoding parameters to a decoding side: the index CT_{index} of the classification parameter CT of the current frame and an index of a winning codebook vector [gₚ; γ] in a gain codebook.

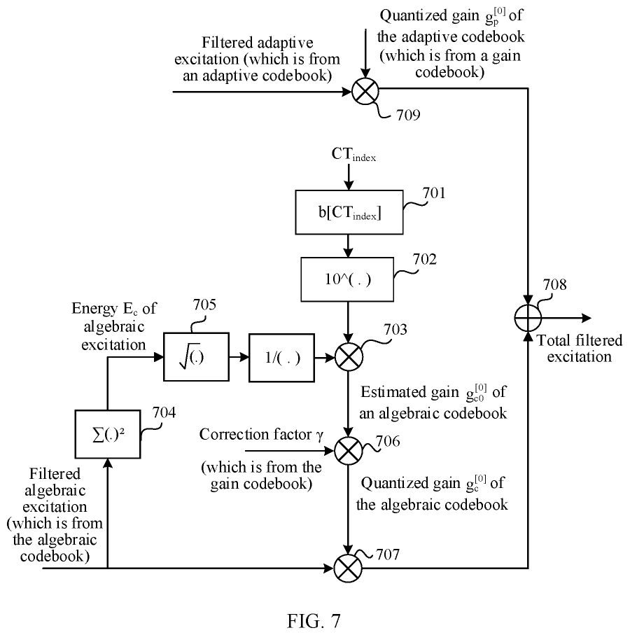

FIG. 7 is a process of calculating an algebraic codebook gain in a first subframe according to Embodiment 2.

As shown in FIG. 7, the index CT_{index} of the classification parameter CT of the current frame is first input to a table lookup module 701. Then, the table lookup module 701 obtains a linear estimated value (which is represented as b[CT_{index}] below) of an algebraic codebook gain in a logarithm domain through table lookup according to the index CT_{index}, and outputs b[CT_{index}] to an exponential calculator 702 with 10 as a base, to obtain a linear estimated value 10^{b[CT}^{_{index}}^{]} of the algebraic codebook gain in a linear domain. Next, the linear estimated value 10^{b[CT}^{_{index}}^{]} of the algebraic codebook gain in the linear domain is output to a multiplier 703. In addition, a value of a square root \sqrt{E_{c}} of energy of an algebraic codebook vector from an algebraic codebook is sequentially calculated through a square summator 704 and a square root calculator 705. The square summator 704 calculates Ec by using the formula (5), and then outputs a reciprocal value of \sqrt{E_{c}} to the multiplier 703, and 10^{b[CT}^{_{index}}^{]} is divided by the reciprocal value of \sqrt{E_{c}} to obtain an estimated gain g_{c0}^{[0]} of the algebraic codebook. Then, the estimated gain g_{c0}^{[0]} of the algebraic codebook is output to a multiplier 706, and the estimated gain g_{c0}^{[0]} of the algebraic codebook is multiplied by a correction factor γ from a gain codebook, to obtain a quantized gain g_{c}^{[0]} of the algebraic codebook. The quantized gain g_{c}^{[0]} of the algebraic codebook may be further output to a multiplier 707, and the quantized gain g_{c}^{[0]} of the algebraic codebook is multiplied by an algebraic codebook vector (filtered algebraic excitation) of the algebraic codebook, to obtain an excited algebraic codebook contribution. Finally, the excited algebraic codebook contribution is output to an adder 708, and the excited algebraic codebook contribution and an excited adaptive codebook contribution are added up to obtain total filtered excitation.

The excited adaptive codebook contribution is obtained by multiplying an adaptive codebook vector (filtered adaptive excitation) that is from an adaptive codebook and that is output to a multiplier 709 by a quantized gain gₚ^{[0]} of the adaptive codebook from the gain codebook. The quantized gain gₚ^{[0]} of the adaptive codebook is directly selected from the gain codebook. Specifically, the gain codebook is searched based on a principle of minimum mean square error MMSE, which refers to the foregoing formula (2).

### Embodiment 3

In a process of calculating an algebraic codebook gain in a first subframe provided in Embodiment 3, a calculation formula of an estimated gain g_{c0}^{[0]} of an algebraic codebook in the first subframe is optimized as follows (which is the same as the formula (7)), to reduce complexity:

$${g}_{c 0}^{[ 0 ]} = 1 {0}^{{a}_{0} + {a}_{1} CT - {log}_{10} ( \sqrt{{E}_{c}} )} = 1 {0}^{{a}_{0} + {a}_{1} C T} \cdot {10}^{- {log}_{10} ( \sqrt{{E}_{c}} )} = \frac{1 {0}^{{a}_{0} + {a}_{1} CT}}{\sqrt{{E}_{c}}} \qquad formula ( 7 )$$

A difference from the foregoing embodiments lies in that a linear estimated value 10^{a}^{₀}^{+a}^{₁}^{CT} of an algebraic codebook gain in a linear domain or a value of a linear estimated value a₀+a₁CT of an algebraic codebook gain in a logarithm domain is not enumerated in a table in advance, but 10^{a}^{₀}^{+a}^{₁}^{CT} is obtained through an exponential operation with 10 as a base.

A process of calculating an estimated gain of an algebraic codebook in the first subframe represented by the formula (7) may be described as follows. First, a linear estimated value a₀+a₁CT of an algebraic codebook gain in a logarithm domain is obtained through calculation according to a classification parameter CT of a current frame. Then, the linear estimated value a₀+a₁CT of the algebraic codebook gain in the logarithm domain is converted into a linear domain through an exponential operation with 10 as a base, to obtain 10^{a}^{₀}^{+a}^{₁}^{CT}. A linear estimated value 10^{a}^{₀}^{+a}^{₁}^{CT} of the algebraic codebook gain in the linear domain is divided by a square root (which is represented as \sqrt{E_{c}}) of energy Ec of an algebraic codebook vector from the algebraic codebook in the linear domain, to obtain the estimated gain g_{c0}^{[0]} of the algebraic codebook in the first subframe. In this way, when the estimated gain of the algebraic codebook in the first subframe is calculated during encoding and decoding, a logarithm log operation and an exponential operation with 10 as a base involved in a part of the factor \sqrt{E_{c}} can be avoided, thereby significantly reducing algorithm complexity.

An encoding side may transmit the following encoding parameters to a decoding side: a frame type CT of the current frame, linear estimation constants a₀ and a₁, and an index of a winning codebook vector [gₚ; γ] in a gain codebook.

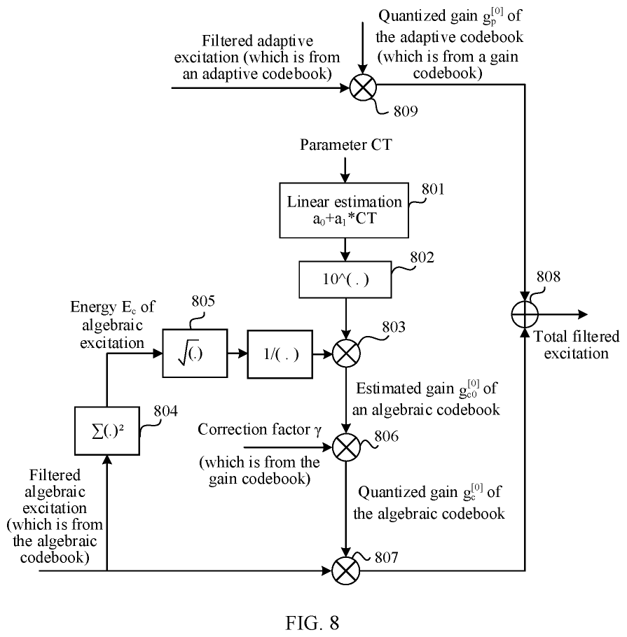

FIG. 8 is a process of calculating an algebraic codebook gain in a first subframe according to Embodiment 3.

As shown in FIG. 8, a classification parameter CT of a current frame is first input to a linear estimation module 801. Then, the linear estimation module 801 calculates a linear estimated value a₀+a₁CT of an algebraic codebook gain in a logarithm domain according to the parameter CT, and outputs a₀+a₁CT to an exponential calculator 802 with 10 as a base to obtain a linear estimated value 10^{a}^{₀}^{+a}^{₁}^{CT} of the algebraic codebook gain in a linear domain. Next, the linear estimated value 10^{a}^{₀}^{+a}^{₁}^{CT} of the algebraic codebook gain in the linear domain is output to a multiplier 803. In addition, a value of a square root \sqrt{E_{c}} of energy of an algebraic codebook vector from an algebraic codebook is sequentially calculated through a square summator 804 and a square root calculator 805. The square summator 804 calculates Ec by using the formula (5), and then outputs a reciprocal value of \sqrt{E_{c}} to the multiplier 803, and 10^{a}^{₀}^{+a}^{₁}^{CT} is divided by the reciprocal value of E_{c} to obtain an estimated gain g_{c0}^{[0]} of the algebraic codebook. Then, the estimated gain g_{c0}^{[0]} of the algebraic codebook is output to a multiplier 806, and the estimated gain g_{c0}^{[0]} of the algebraic codebook is multiplied by a correction factor γ from a gain codebook, to obtain a quantized gain g_{c}^{[0]} of the algebraic codebook. The quantized gain g_{c}^{[0]} of the algebraic codebook may be further output to a multiplier 807, and the quantized gain g_{c}^{[0]} of the algebraic codebook is multiplied by an algebraic codebook vector (filtered algebraic excitation) of the algebraic codebook, to obtain an excited algebraic codebook contribution. Finally, the excited algebraic codebook contribution is output to an adder 808, and the excited algebraic codebook contribution and an excited adaptive codebook contribution are added up to obtain total filtered excitation.

The excited adaptive codebook contribution is obtained by multiplying an adaptive codebook vector (filtered adaptive excitation) that is from an adaptive codebook and that is output to a multiplier 809 by a quantized gain gₚ^{[0]} of the adaptive codebook from the gain codebook. The quantized gain gₚ^{[0]} of the adaptive codebook is directly selected from the gain codebook. Specifically, the gain codebook is searched based on a principle of minimum mean square error MMSE, which refers to the foregoing formula (2).

### Embodiment 4

In a process of calculating an algebraic codebook gain in a first subframe provided in Embodiment 4, a calculation formula of an estimated gain g_{c0}^{[0]} of an algebraic codebook in the first subframe is optimized as follows, to reduce complexity:

$${g}_{c 0}^{[ 0 ]} = 1 {0}^{{a}_{0} + {a}_{1} CT - {log}_{10} ( \sqrt{{E}_{c}} )} = 1 {0}^{{a}_{0} + {a}_{1} C T} \cdot {10}^{- {log}_{10} ( \sqrt{{E}_{c}} )} \qquad formula ( 12 )$$

Same as Embodiment 1, because a linear estimated value 10^{a}^{₀}^{+a}^{₁}^{CT} of an algebraic codebook gain in a linear domain is related to only a classification parameter CT and estimation constants a₀ and a₁ in a logarithm domain, a value of 10^{a}^{₀}^{+a}^{₁}^{CT} may be enumerated in a table in advance. 10^{a}^{₀}^{+a}^{₁}^{CT} represents the linear estimated value of the algebraic codebook gain in the linear domain. A codec may maintain a mapping table b. Each entry in the table b includes two values: an index CT_{index} of a classification parameter CT and a linear estimated value 10^{a}^{₀}^{+a}^{₁}^{CT} of an algebraic codebook gain in the linear domain. In this way, the codec may directly obtain a value of 10^{a}^{₀}^{+a}^{₁}^{CT} corresponding to a parameter CT of a current frame through table lookup, to avoid a case that calculation is performed when the codec runs, thereby reducing algorithm complexity.

$$\begin{matrix}b [ C {T}_{i n d e x} ] = 1 {0}^{{a}_{0} + {a}_{1} C T} & which is the same as the\end{matrix} \qquad formul a ( 8 )$$

A calculation process of the formula (12) may be further simplified as:

$${g}_{c 0}^{[ 0 ]} = b [ C {T}_{i n d e x} ] \cdot {10}^{- {log}_{10} ( \sqrt{{E}_{c}} )} \qquad formula ( 13 )$$

A process of calculating an estimated gain of an algebraic codebook in the first subframe represented by the formula (13) may be described as follows. First, a linear estimated value 10^{a}^{₀}^{+a}^{₁}^{CT} of an algebraic codebook gain in a linear domain is obtained through table lookup according to an index CT_{index} of a classification parameter CT of a current frame. In addition, an additive inverse of an energy parameter log₁₀(\sqrt{E_{c}}) of an algebraic codebook vector from an algebraic codebook is calculated, and an exponential operation with 10 as a base is performed on the additive inverse, to obtain 10^{-log}^{₁₀}⁽{square root over (^{E}^{_{c}}⁾)}. Finally, the linear estimated value 10^{a}^{₀}^{+a}^{₁}^{CT} of the algebraic codebook gain in the linear domain is multiplied by 10^{-log}^{₁₀}⁽{square root over (^{E}^{_{c}}⁾)}, to obtain an estimated gain g_{c0}^{[0]} of the algebraic codebook. In this way, when the estimated gain of the algebraic codebook in the first subframe is calculated during encoding and decoding, an exponential operation with 10 as a base involved in the linear estimated value of the algebraic codebook gain can be avoided, thereby significantly reducing algorithm complexity.

An encoding side may transmit the following encoding parameters to a decoding side: the index CT_{index} of the classification parameter CT of the current frame and an index of a winning codebook vector [gₚ; γ] in a gain codebook.

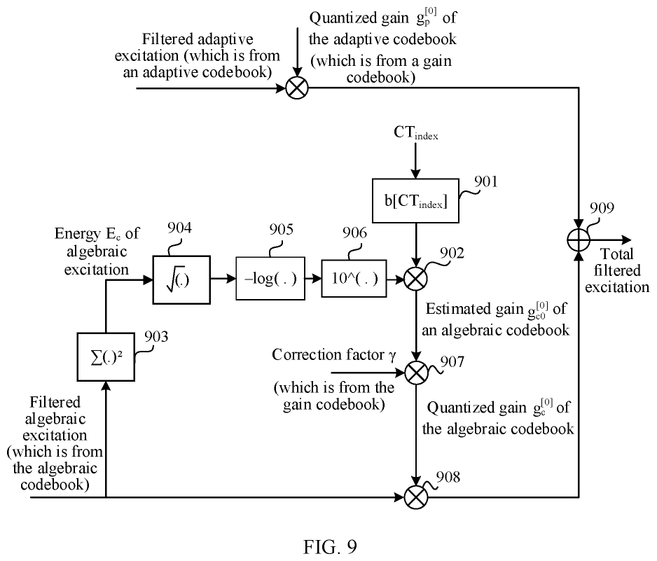

FIG. 9 is a process of calculating an algebraic codebook gain in a first subframe according to Embodiment 4.

As shown in FIG. 9, the index CT_{index} of the classification parameter CT of the current frame is first input to a table lookup module 901. Then, the table lookup module 901 obtains a linear estimated value (which is represented as b[CT_{index}] below) of an algebraic codebook gain in a linear domain through table lookup according to the index CT_{index}, and outputs b[CT_{index}] to a multiplier 902. In addition, a value of a square root \sqrt{E_{c}} of energy of an algebraic codebook vector from an algebraic codebook is sequentially calculated through a square summator 903 and a square root calculator 904. The square summator 903 calculates Ec by using the formula (5), and then outputs \sqrt{E_{c}} to a calculator 905, and an additive inverse of a value obtained by performing a logarithm log operation on \sqrt{E_{c}} is calculated to obtain −log₁₀(\sqrt{E_{c}}). Then, −log₁₀(\sqrt{E_{c}}) is output to a calculator 906, and an exponential operation with 10 as a base is performed on −log₁₀(E_{c}), to obtain 10^{-log}^{₁₀}⁽{square root over (^{E}^{_{c}}⁾)}. 10^{-log}^{₁₀}⁽{square root over (^{E}^{_{c}}⁾)}is output to the multiplier 902, 10^{-log}^{₁₀}⁽{square root over (^{E}^{_{c}}⁾)}is multiplied by b[CT_{index}], to obtain an estimated gain g_{c0}^{[0]} of an algebraic codebook. Then, the estimated gain g_{c0}^{[0]} of the algebraic codebook is output to a multiplier 907, and the estimated gain g_{c0}^{[0]} of the algebraic codebook is multiplied by a correction factor γ from a gain codebook, to obtain a quantized gain g_{c}^{[0]} of the algebraic codebook. The quantized gain g_{c}^{[0]} of the algebraic codebook may be further output to a multiplier 908, and the quantized gain g_{c}^{[0]} of the algebraic codebook is multiplied by an algebraic codebook vector (filtered algebraic excitation) of the algebraic codebook, to obtain an excited algebraic codebook contribution. Finally, the excited algebraic codebook contribution is output to an adder 909, and the excited algebraic codebook contribution and an excited adaptive codebook contribution are added up to obtain total filtered excitation.

The excited adaptive codebook contribution is obtained by multiplying an adaptive codebook vector (filtered adaptive excitation) that is from an adaptive codebook and that is output to a multiplier 910 by a quantized gain gₚ^{[0]} of the adaptive codebook from the gain codebook. The quantized gain g_{c0}^{[0]} of the adaptive codebook is directly selected from the gain codebook. Specifically, the gain codebook is searched based on a principle of minimum mean square error MMSE, which refers to the foregoing formula (2).

In Embodiment 4, b[CT_{index}]=a₀+a₁CT, that is, only a value of a₀+a₁CT is enumerated in a table in advance by using the table b. In this case, a calculation process of the formula (12) may be further simplified as:

$${g}_{c 0}^{[ 0 ]} = 1 {0}^{b [ C {T}_{index} ] - {log}_{10} ( \sqrt{{E}_{c}} )} \qquad formula ( 14 )$$

A process of calculating an estimated gain of an algebraic codebook in the first subframe represented by the formula (14) may be described as follows. First, a linear estimated value of an algebraic codebook gain in a logarithm domain is obtained through table lookup according to an index CT_{index} of a classification parameter CT of a current frame. In addition, energy log₁₀(\sqrt{E_{c}}) of an algebraic codebook vector from an algebraic codebook is subtracted from the linear estimated value a₀+a₁CT of the algebraic codebook gain in the logarithm domain, to obtain a₀+a₁CT−log₁₀(\sqrt{E_{c}}). Finally, an exponential operation with 10 as a base is performed on a₀+a₁CT−log₁₀(\sqrt{E_{c}}), to obtain g_{c0}^{[0]}. In the calculation process shown in the formula (14), the linear estimated value of the algebraic codebook in the logarithm domain can be obtained through table lookup, without calculation of the codec, thereby reducing a calculation amount.

In the foregoing embodiments, a value of the classification parameter CT of the current frame may be selected based on a signal type. For example, for a narrowband signal, for an unvoiced frame, a voiced frame, a generic frame, or a transition frame, values of the parameter CT are respectively set to 1, 3, 5, and 7, and for a broadband signal, the values of the parameter CT are respectively set to 0, 2, 4, and 6. Signal classification is described below, and is not expanded herein,

### Signal Type

There may be different methods for determining classification (a parameter CT) of a frame. For example, basic classification is performed according to only voiced or unvoiced. In another example, more types such as voiced or strong unvoiced may be enhanced.

The signal classification may be performed in the following three steps. First, a speech active detector (speech active detector, SAD) distinguishes between a valid speech frame and an invalid speech frame. If the invalid speech frame such as ground noise (ground noise) is detected, classification is ended, and an encoding frame is generated by using a comfort noise generator (comfort noise generator, CNG). If the valid speech frame is detected, the frame is further classified, to distinguish an unvoiced frame. If the frame is further classified into an unvoiced signal, classification is ended, and the frame is encoded by using an encoding method most suitable for the unvoiced signal. Otherwise, it is further determined whether the frame is stable voiced. If the frame is classified into a stable voiced frame, the frame is encoded by using an encoding method most suitable for a stable voiced signal. Otherwise, the frame may include a non-stable signal segment such as a voiced onset or rapidly evolving voiced signal.

The unvoiced signal may be classified based on the following parameters: voicing measure fx, an average spectral tilt ēₜ, a maximum short-time energy increment dEo and a maximum short time energy deviation dE that are at a low level. An algorithm for distinguishing the unvoiced signal is not limited in this application, for example, an algorithm mentioned in the following document Jelinek, M., et al., “Advances in source-controlled variable bitrate wideband speech coding”, Special Workshop in MAUI(SWIM); Lectures by masters in speech processing, Maui, Jan. 12-24, 2004 may be used, which is incorporated herein by reference in its entirety.

If a frame is not classified into a valid frame or an unvoiced frame, it is tested whether the frame is a stable voiced frame. The stable voiced frame may be classified based on the following parameters: a normalization correlation r̅ₓ of each subframe (with 1/4 subsample resolution), an average spectral tilt ēₜ, and open-loop pitch estimation in all subframes (with 1/4 subsample resolution). An algorithm for distinguishing the sable voiced frame is not limited in this application.

In the foregoing embodiments, in addition to the classification parameter CT, the linear estimated gain of the algebraic codebook in the first subframe of the current frame is further related to an estimation constant aᵢ. The estimation constant aᵢ may be determined through training by using data of a big sample.

### Calculation of an Estimation Constant

Training data of a big sample may include a large quantity of various speech signals in different languages, different genders, different ages, different environments, and the like. In addition, it is assumed that the training data of the big sample includes (N+1) frames.

An estimation coefficient is found by minimizing a mean square error between an estimated gain of an algebraic codebook and an optimal gain in a logarithm domain on all the frames in the training data of the big sample.

For a first subframe in an n^{th} frame, energy of the mean square error is given by using the following formula:

$${E}_{e s t}^{( 1 )} = {{\sum }_{n = 0}^{N} [ {G}_{c 0}^{( 1 )} ( n ) - {log}_{10} ( {g}_{c , opt}^{( 1 )} ( n ) ) ]}^{2} \qquad formula ( 15 )$$

In the first subframe of the n^{th} frame, an estimated gain of an algebraic codebook in a logarithm domain is given by using the following formula:

$${G}_{c 0}^{( 1 )} ( n ) = {a}_{0} + {a}_{1} t ( n ) - {log}_{10} ( \sqrt{{E}_{i} ( n ) )} \qquad formula ( 16 )$$

where i=0, . . . , L−1. L represents L samples of input voice signals. Eᵢ(n) represents energy of an algebraic codebook vector from an algebraic codebook in the n^{th} frame, which may refer to calculation in the foregoing formula (5).

After the formula (16) is substituted, the formula (15) is changed into:

$${E}_{e s t}^{( 1 )} = {{\sum }_{n = 0}^{N} [ {a}_{0} + {a}_{1} t ( n ) - {log}_{10} ( \sqrt{{E}_{i} ( n ) )} - {log}_{10} ( {g}_{c , opt}^{( 1 )} ( n ) ) ]}^{2} \qquad formula ( 17 )$$

In the formula (17), g_{c,opt}⁽¹⁾(n) represents an optimal algebraic codebook gain in the first subframe, which may be obtained through calculation by using the following formula (18) and formula (19):

$${g}_{c , o p t} ( n ) = \frac{{c}_{0} {c}_{3} - {c}_{1} {c}_{4}}{{c}_{0} {c}_{2} - {c}_{4}^{2}} \qquad formula ( 18 )$$

Constants or correlation coefficients c₀, c₁, c₂, c₃, c₄, and c₅ are obtained through calculation by using the following formula:

$${c}_{o} = {y}^{t} y , {c}_{1} = {x}^{t} y , {c}_{2} = {z}^{t} z , {c}_{3} = {x}^{t} z , {c}_{4} = {y}^{t} z , and {c}_{5} = {x}^{t} x \qquad formula ( 19 )$$

A process of calculating a minimum mean square error MSE is simplified by defining a normalized gain Gᵢ⁽¹⁾(n) of an algebraic codebook in the logarithm domain:

$${E}_{e s t}^{( 1 )} = {{\sum }_{n = 0}^{N} [ {a}_{0} + {a}_{1} t ( n ) - {G}_{i}^{( 1 )} ( n ) ]}^{2} \qquad formula ( 20 )$$

where Gᵢ⁽¹⁾(n)=log₁₀(\sqrt{Eᵢ(n)})+log₁₀(g_{c,opt}⁽¹⁾(n)).

A solution (that is, optimal values of the estimation constants a₀ and a₁) of the defined minimum mean square error MSE is obtained by using the following pair of partial derivatives:

$$\frac{\partial }{\partial {a}_{0}} {E}_{e s t}^{( 1 )} = o , and \frac{\partial }{\partial {a}_{1}} {E}_{e s t}^{( 1 )} = o \qquad formula ( 21 )$$

So far, the optimal values of the estimation constants a₀ and a₁ can be determined. Expressions of the optimal values of the estimation constants a₀ and a₁ are not provided herein, that is, solution of the formula (21) is not shown, and the expressions are relatively complex. During actual application, the optimal value can be calculated in advance by using calculation software such as MATLAB.

For a second subframe and a subsequent subframe in the n^{th} frame, energy of a mean square error is given by using the following formula:

$${E}_{e s t}^{( k )} = {{\sum }_{n = 0}^{N} [ {G}_{c 0}^{( k )} ( n ) - {G}_{c , opt}^{( k )} ( n ) ]}^{2} \qquad formula ( 22 )$$

where k≥2, G_{c,opt}^{(k)} (n)=log₁₀(g_{c,opt}^{(k)}(n)), and a value of g_{c,opt}^{(k)} (n) is also obtained through calculation by using the foregoing formula (18) and formula (19); and G_{c0}^{(k)}(n) represents an estimated gain of an algebraic codebook in a logarithm domain in a k^{th} subframe. G_{c0}^{(k)}(n) is obtained through calculation by using the following formula (23):

$${G}_{c 0}^{( k )} ( n ) = {b}_{0} + {b}_{1} CT + {\sum }_{i = 1}^{k} {b}_{i + 1} {log}_{10} ( {g}_{c}^{[ i - 1 ]} ) + {\sum }_{i = 1}^{k} {b}_{k + 1 + i} {g}_{p}^{[ i - 1 ]} \qquad formula ( 23 )$$

To solve optimal values of estimation constants b₀, b₁, . . . , and bₖ that implement the minimum mean square error MSE, similar to the solution method in the first subframe, a partial derivative of the formula (22) may be obtained.

So far, the optimal values of the estimation constants b₀, b₁, . . . , and bₖ can be determined. Expressions of the optimal values of the estimation constants b₀, b₁, . . . , and bₖ are not provided herein, and the expressions are relatively complex. During actual application, the optimal value can be calculated in advance by using calculation software such as MATLAB.

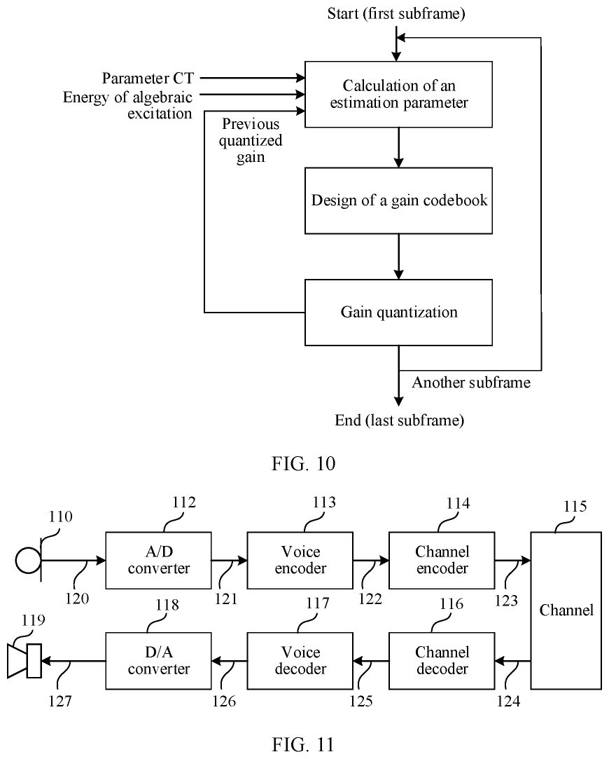

As shown in FIG. 10, the calculated estimation constants may be used for designing a gain codebook for each subframe, and gain quantization of each subframe can be further determined according to the estimation constants and the gain codebook. Based on the foregoing, estimation of the algebraic codebook gain is slightly different in each subframe, and an estimation coefficient is obtained through a minimum mean square error MSE. The gain codebook may be designed with reference to a KMEANS algorithm in the following document: MacQueen, J. B. (1967), “Some Methods for classification and Analysis of Multivariate Observations”, Proceedings of 5th Berkeley Symposium on Mathematical Statistics and Probability, University of California Press. pp. 281-297, which is incorporated herein by reference in its entirety.

FIG. 11 shows a voice communication system 110 including a voice encoding apparatus 113 and a voice decoding apparatus 117 according to an embodiment of this application. The voice communication system 110 supports transmission of a voice signal through a communication channel 115. The communication channel 115 may be a wireless communication link or may be a wired link formed by a conducting wire and the like. The communication channel 115 may support a plurality of voice communication that is performed simultaneously and needs to share bandwidth resources Without being limited to communication between apparatuses, the communication channel 115 may also be extended to a memory unit within a single apparatus for implementing shared communication, for example, a memory unit of a single apparatus for recording and storing encoded voice signals for later playback.

At a transmitter end, a voice acquisition apparatus 11 such as a microphone converts voice into an analog voice signal 120 provided to an analog to digital (A/D) converter 112. A function of the A/D converter 112 is to convert the analog voice signal 120 into a digital voice signal 121. A voice encoding apparatus 113 encodes the digital voice signal 121 to generate a group of encoding parameters 122 in a binary form and transmits the encoding parameters to a channel encoder 114 through a communication component. The channel encoder 114 performs a channel encoding operation such as adding redundancy on the encoding parameters 122 to form a bit stream 123, and transmits the bit stream through the communication channel 115.

At a receiver end, a channel decoder 116 performs a channel decoding operation on the bit stream 124 received through the communication component, for example, detects and corrects, by using redundancy information in the bit stream 124, a channel error occurring during transmission. A voice decoding apparatus 117 converts the bit stream 125 received from the channel decoder back to the encoding parameters for creating a synthesized voice signal 126. A digital to analog (D/A) converter 108 converts the synthesized voice signal 126 reconstructed in the voice decoding apparatus 117 back to the analog voice signal 127. Finally, the analog voice signal 127 is played through a sound playback apparatus such as a speaker unit 119.

That the voice encoding apparatus 113 encodes a voice signal to obtain an encoding parameter, and the voice decoding apparatus 117 reconstructs the voice signal by using the encoding parameter carried in a bit stream may refer to the above content. Details are not described again.

Each device at the transmitter end may be integrated into one electronic device, and each device at the receiver end may be integrated into another electronic device. In this case, the two electronic devices communicate via a communication channel formed by a wired or wireless link, for example, transmitting an encoding parameter, for example, transmitting an encoding parameter. Each device at the transmitter end and each device at the receiver end may alternatively be integrated into a same electronic device. In this case, data exchange, that is, communication, for example, transmission of an encoding parameter, is implemented between the transmitter end and the receiver end inside the electronic device through a shared memory unit.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1-27. (canceled)

28. A method for encoding a sound signal, applied to a first subframe in a current frame, wherein the method comprises:
receiving a frame classification parameter index of the current frame;
searching a table for a linear estimated value of an algebraic codebook gain in a linear domain according to the frame classification parameter index of the current frame, wherein each entry in a first mapping table comprises a linear estimated value of an algebraic codebook gain in the linear domain;
calculating energy of an algebraic codebook vector from an algebraic codebook;
dividing the linear estimated value of the algebraic codebook gain in the linear domain by a square root of the energy of the algebraic codebook vector, to obtain an estimated gain of the algebraic codebook; and
multiplying the estimated gain of the algebraic codebook by a correction factor, to obtain a quantized gain of the algebraic codebook, wherein the correction factor is from a winning codebook vector, and the winning codebook vector is selected from a gain codebook.

29. The method according to claim 28, wherein the method further comprises:
transmitting an encoding parameter, wherein the encoding parameter comprises: the frame classification parameter index of the current frame and an index of the winning codebook vector in the gain codebook.

30. The method according to claim 28, wherein the method further comprises:
searching a table for a linear estimated value of an algebraic codebook gain in a logarithm domain according to the frame classification parameter index of the current frame, wherein each entry in the first mapping table comprises a linear estimated value of an algebraic codebook gain in the logarithm domain;
converting the linear estimated value of the algebraic codebook gain in the logarithm domain into a linear domain through an exponential operation, to obtain a linear estimated value of the algebraic codebook gain in the linear domain;
calculating energy of an algebraic codebook vector from an algebraic codebook;
dividing the linear estimated value of the algebraic codebook gain in the linear domain by a square root of the energy of the algebraic codebook vector, to obtain an estimated gain of the algebraic codebook; and
multiplying the estimated gain of the algebraic codebook by a correction factor, to obtain a quantized gain of the algebraic codebook, wherein the correction factor is from a winning codebook vector, and the winning codebook vector is selected from a gain codebook.

31. The method according to claim 28, wherein the method further comprises:
performing linear estimation by using a linear estimation constant in the first subframe and a frame type of the current frame, to obtain a linear estimated value of an algebraic codebook gain in a logarithm domain;
converting the linear estimated value of the algebraic codebook gain in the logarithm domain into a linear domain through an exponential operation, to obtain a linear estimated value of the algebraic codebook gain in the linear domain;
calculating energy of an algebraic codebook vector from an algebraic codebook;
dividing the linear estimated value of the algebraic codebook gain in the linear domain by a square root of the energy of the algebraic codebook vector, to obtain an estimated gain of the algebraic codebook; and
multiplying the estimated gain of the algebraic codebook by a correction factor, to obtain a quantized gain of the algebraic codebook, wherein the correction factor is from a winning codebook vector, and the winning codebook vector is selected from a gain codebook.

32. A method for decoding a sound signal, applied to a first subframe in a current frame, wherein the method comprises:
receiving an encoding parameter, wherein the encoding parameter comprises: a frame classification parameter index of the current frame and an index of a winning codebook vector;
searching a table for a linear estimated value of an algebraic codebook gain in the linear domain based on the frame classification parameter index of the current frame, wherein each entry in a first mapping table comprises a linear estimated value of an algebraic codebook gain in the linear domain;
calculating energy of an algebraic codebook vector from an algebraic codebook;
dividing the linear estimated value of the algebraic codebook gain in the linear domain by a square root of the energy of the algebraic codebook vector, to obtain an estimated gain of the algebraic codebook; and
multiplying the estimated gain of the algebraic codebook by a correction factor, to obtain a quantized gain of the algebraic codebook, wherein the correction factor is from the winning codebook vector, and the winning codebook vector is selected from a gain codebook based on the index of the winning codebook vector.

33. The method according to claim 32, wherein the method further comprises:
receiving an encoding parameter, wherein the encoding parameter comprises: a frame classification parameter index of the current frame and an index of a winning codebook vector;
searching a table for a linear estimated value of an algebraic codebook gain in a logarithm domain based on the frame classification parameter index of the current frame, wherein each entry in the first mapping table comprises a linear estimated value of an algebraic codebook gain in the logarithm domain;
converting the linear estimated value of the algebraic codebook gain in the logarithm domain into a linear domain through an exponential operation, to obtain a linear estimated value of the algebraic codebook gain in the linear domain;
calculating energy of an algebraic codebook vector from an algebraic codebook;
dividing the linear estimated value of the algebraic codebook gain in the linear domain by a square root of the energy of the algebraic codebook vector, to obtain an estimated gain of the algebraic codebook; and
multiplying the estimated gain of the algebraic codebook by a correction factor, to obtain a quantized gain of the algebraic codebook, wherein the correction factor is from the winning codebook vector, and the winning codebook vector is selected from a gain codebook based on the index of the winning codebook vector.

34. The method according to claim 28, wherein the method further comprises:
calculating energy Ec of an algebraic codebook vector from an algebraic codebook, performing a logarithm operation with 10 as a base on a square root of the energy, calculating an additive inverse of a value obtained through the logarithm operation, and then performing an exponential operation with 10 as a base, to obtain 10^{-log}^{₁₀}⁽{square root over (^{E}^{_{c}}⁾)};
multiplying the linear estimated value of the algebraic codebook gain in the linear domain by 10^{-log}^{₁₀}⁽{square root over (^{E}^{_{c}}⁾)}, to obtain an estimated gain g_{c0}^{[0]} of the algebraic codebook; and
multiplying the estimated gain g_{c0}^{[0]} of the algebraic codebook by a correction factor, to obtain a quantized gain of the algebraic codebook, wherein the correction factor is from a winning codebook vector, and the winning codebook vector is selected from a gain codebook.

35. The method according to claim 32, wherein the method further comprises:
calculating energy Ec of an algebraic codebook vector from an algebraic codebook, performing a logarithm operation with 10 as a base on a square root of the energy, calculating an additive inverse of a value obtained through the logarithm operation, and then performing an exponential operation with 10 as a base, to obtain 10^{-log}^{₁₀}⁽{square root over (^{E}^{_{c}}⁾)};
multiplying the linear estimated value of the algebraic codebook gain in the linear domain by 10^{-log}^{₁₀}⁽{square root over (^{E}^{_{c}}⁾)}, to obtain an estimated gain of the algebraic codebook; and
multiplying the estimated gain g_{c0}^{[0]} of the algebraic codebook by a correction factor, to obtain a quantized gain of the algebraic codebook gain, wherein the correction factor is from the winning codebook vector, and the winning codebook vector is selected from a gain codebook based on the index of the winning codebook vector.

36. The method according to claim 28, wherein the method further comprises:
multiplying the quantized gain of the algebraic codebook gain by the algebraic codebook vector from the algebraic codebook, to obtain an excitation contribution of the algebraic codebook;
multiplying a quantized gain of an adaptive codebook comprised in the winning codebook vector selected from the gain codebook by an adaptive codebook vector from the adaptive codebook, to obtain an excitation contribution of the adaptive codebook; and
adding up the excitation contribution of the algebraic codebook and the excitation contribution of the adaptive codebook, to obtain total excitation.

37. An electronic device, comprising:
one or more processors and a memory, wherein the memory is coupled to the one or more processors, the memory is configured to store computer program code, the computer program code comprises computer instructions, and the one or more processors invoke the computer instructions to enable the apparatus to perform:
receiving a frame classification parameter index of the current frame;
searching a table for a linear estimated value of an algebraic codebook gain in a linear domain according to the frame classification parameter index of the current frame, wherein each entry in a first mapping table comprises a linear estimated value of an algebraic codebook gain in the linear domain;
calculating energy of an algebraic codebook vector from an algebraic codebook;
dividing the linear estimated value of the algebraic codebook gain in the linear domain by a square root of the energy of the algebraic codebook vector, to obtain an estimated gain of the algebraic codebook; and
multiplying the estimated gain of the algebraic codebook by a correction factor, to obtain a quantized gain of the algebraic codebook, wherein the correction factor is from a winning codebook vector, and the winning codebook vector is selected from a gain codebook.

38. The electronic device according to claim 37, further comprising a microphone and a speaker.

39. The apparatus according to claim 37, wherein the one or more processors invoke the computer instructions to further enable the apparatus to perform:
transmitting an encoding parameter, wherein the encoding parameter comprises: the frame classification parameter index of the current frame and an index of the winning codebook vector in the gain codebook.

40. The apparatus according to claim 37, wherein the one or more processors invoke the computer instructions to further enable the apparatus to perform:
searching a table for a linear estimated value of an algebraic codebook gain in a logarithm domain according to the frame classification parameter index of the current frame, wherein each entry in the first mapping table comprises a linear estimated value of an algebraic codebook gain in the logarithm domain;
converting the linear estimated value of the algebraic codebook gain in the logarithm domain into a linear domain through an exponential operation, to obtain a linear estimated value of the algebraic codebook gain in the linear domain;
calculating energy of an algebraic codebook vector from an algebraic codebook;
dividing the linear estimated value of the algebraic codebook gain in the linear domain by a square root of the energy of the algebraic codebook vector, to obtain an estimated gain of the algebraic codebook; and
multiplying the estimated gain of the algebraic codebook by a correction factor, to obtain a quantized gain of the algebraic codebook, wherein the correction factor is from a winning codebook vector, and the winning codebook vector is selected from a gain codebook.

41. The apparatus according to claim 37, wherein the one or more processors invoke the computer instructions to further enable the apparatus to perform:
performing linear estimation by using a linear estimation constant in a first subframe and a frame type of the current frame, to obtain a linear estimated value of an algebraic codebook gain in a logarithm domain;
converting the linear estimated value of the algebraic codebook gain in the logarithm domain into a linear domain through an exponential operation, to obtain a linear estimated value of the algebraic codebook gain in the linear domain;
calculating energy of an algebraic codebook vector from an algebraic codebook;
dividing the linear estimated value of the algebraic codebook gain in the linear domain by a square root of the energy of the algebraic codebook vector, to obtain an estimated gain of the algebraic codebook; and
multiplying the estimated gain of the algebraic codebook by a correction factor, to obtain a quantized gain of the algebraic codebook, wherein the correction factor is from a winning codebook vector, and the winning codebook vector is selected from a gain codebook.
